(19) United States
(12) Patent Application Publication
(10) Pub. No.: US 2008/0141839 A1
(43) Pub. Date: Jun. 19, 2008

(54) Method of manufacturing pleated disposable garment

(76) Inventors: Paul T. Van Gompel, Hortonville, WI (US); LuAnn M. Beckman, Neenah, WI (US); Eric John R. Gilgenbach, Winneconne, WI (US); John T. Hahn, Merrill, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/638,995

(22) Filed: Dec. 13, 2006

(51) Int. Cl. B26D 1/44; B23P 11/00

(52) U.S. Cl. 83/39; 29/428

(57) ABSTRACT

Method for manufacturing a disposable garment having shaped leg elastic members and may include pleats or folds in the waist region of the garment. The shaped leg elastic members are shaped by a cutting step.

### BACKGROUND OF THE INVENTION

This invention relates generally to a method for making disposable garment for personal wear, and more particularly to such a disposable garment with improved fit and reduced leakage.

Disposable garments are known for use in the manner of underpants for children and adults, garments worn like training pants for toddlers, and garments worn like diapers for infants. Disposable absorbent garments are designed to absorb and contain bodily fluids, but otherwise have a limited period of use before its ability to perform its intended function is exhausted. In particular, such disposable absorbent garments are intended to be discarded after one or more insults instead of being laundered.

Typically, it is desirable for disposable garments to fit close to the body of the wearer for comfort and discretion. Presently available disposable garments for wear about one's waist include a substantially liquid impermeable outer cover, a liquid permeable bodyside liner in a superposed relation with the outer cover, and an absorbent structure located between the outer cover and the bodyside liner for taking in and retaining liquid body exudates. The side edges of the garment form a pair of leg openings when the disposable garment is worn and the ends of the garment together form the waist opening thereof. Elastic components such as waist elastics, leg elastics and containment flaps are commonly used to enhance the fit and inhibit leakage from the garment.

While disposable garments have been known for many years, the materials used to construct them have continuously evolved as a result of new technologies for formulating and manufacturing disposable materials. Materials may be selected for performance or to provide a cost advantage, particularly given that many manufacturers produce disposable garments and disposable absorbent garments in very large quantities. One aspect of evolution has been the development and availability of stretchable materials to replace previously non-stretchable components in order to provide improvements in the way in which the garments fit and improvements in the range of fit of the garments.

With the advent of the availability of stretchable materials to construct disposable absorbent garments, various configurations for garments incorporating stretchable materials have been described. Simultaneous with the development of stretchable materials having lower cost and/or improved properties for use in disposable garments, developments with regard to the structural features of disposable garments have also occurred.

Even though significant and numerous advancements have occurred in the materials and structural features available for the construction of disposable garments, there remain opportunities for improvement in the fit, containment, and ventilation capacity of such garments. For example, there remains a need for a method of making a disposable garment that provides improved fit on the wearer while inhibiting leakage and keeping the waste materials contained by the garment away from the skin of the wearer.

### SUMMARY OF THE INVENTION

In one aspect of the present invention is a method of manufacturing a disposable garment for wearing about the lower torso of a person, the garment comprising a crotch region extending longitudinally between and interconnecting a front waist region and a back waist region. The method includes the steps of: orienting a pair of elastic leg bands in a longitudinal direction; laterally spacing the pair of elastic leg bands apart from one another; and attaching each one of the pair of elastic leg bands to a lateral edge margin of the crotch region of the disposable garment. Further included is a step of cutting through the pair elastic leg bands and the lateral edge margin of the disposable garment to define a shaped leg cut-out.

In yet another aspect of the present invention there is a method of manufacture of a disposable garment including the step of forming a composite web. To form a composite web, provided is a continuous web of absorbent assembly having lateral edge margins and comprising a plurality of discrete pads. The discrete pads are spaced apart longitudinally in a machine direction and disposed between a liner web and a backsheet web. There is a pair of side panels, spaced apart in a lateral direction, and joined to the lateral edge margins of the continuous web of absorbent assembly. Discrete, laterally and longitudinally spaced pairs of leg elastic members are joined to an outer layer web to sandwich the leg elastic members between the outer layer web and the side panel webs. Once the composite web is formed, a step of cutting through the composite web at an outer layer, the side panel webs, and the leg elastic members define a pair leg of cut-outs at laterally spaced outboard edges. Cutting the composite web at longitudinally spaced intervals form discrete disposable garments.

The foregoing paragraphs have been provided by way of introduction, and are not intended to limit the scope of the following claims. The following embodiments will be understood by reference to the detailed description taken in conjunction with the accompanying drawings.

### BRIEF DESCRIPTION OF THE DRAWINGS

FIG. 1 is a top plan view of one embodiment of a disposable garment of the present invention in the form of a diaper illustrated in an unfolded and laid flat condition to show the surface of the diaper that contacts the skin of the wearer;

FIG. 2 is a top plan view of an embodiment of a disposable garment similar to FIG. 1 but with portions cut away to reveal internal construction, and non-tapered leg elastics;

FIG. 3 is an exploded cross-section taken in the plane of line 3-3 in FIG. 1;

FIG. 4 is a top perspective view of another embodiment of a disposable garment of the present invention in the form of a diaper illustrated in an unfolded and laid flat condition;

FIG. 5 is an exploded cross-section taken in the plane of line 5-5 of FIG. 1;

FIG. 6 is an exploded cross-section taken in the plane of line 6-6 of FIG. 1;

FIGS. 7A and 7B together form a schematic diagram showing an embodiment of the manufacturing system for making the disposable garment of FIG. 1;

FIG. 8 is a partial perspective view of another section of the of the manufacturing system of FIG. 7 used to fold the absorbent member; and

FIG. 9 is a partial perspective view of two sections of the manufacturing system of FIG. 7 which are used to apply leg elastics to a web and to cut the web into discrete disposable garments.

Corresponding reference characters indicate corresponding parts throughout the several views of the drawings.

### DETAILED DESCRIPTION OF THE INVENTION

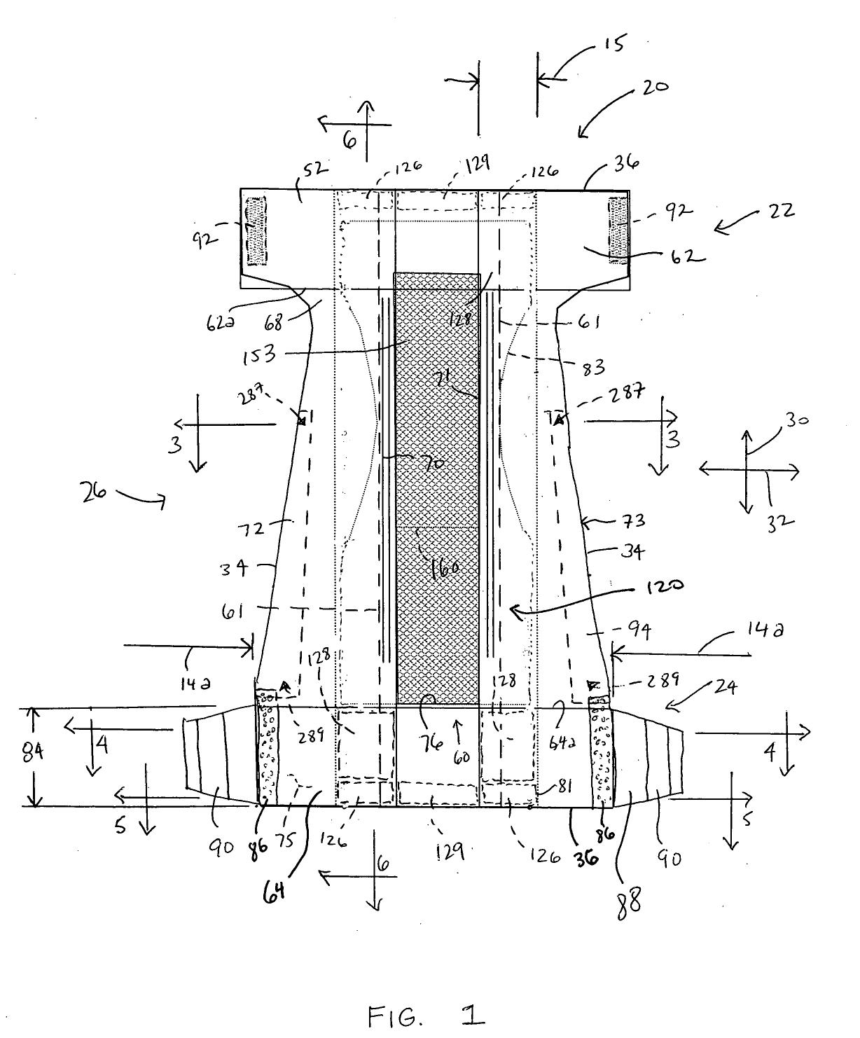

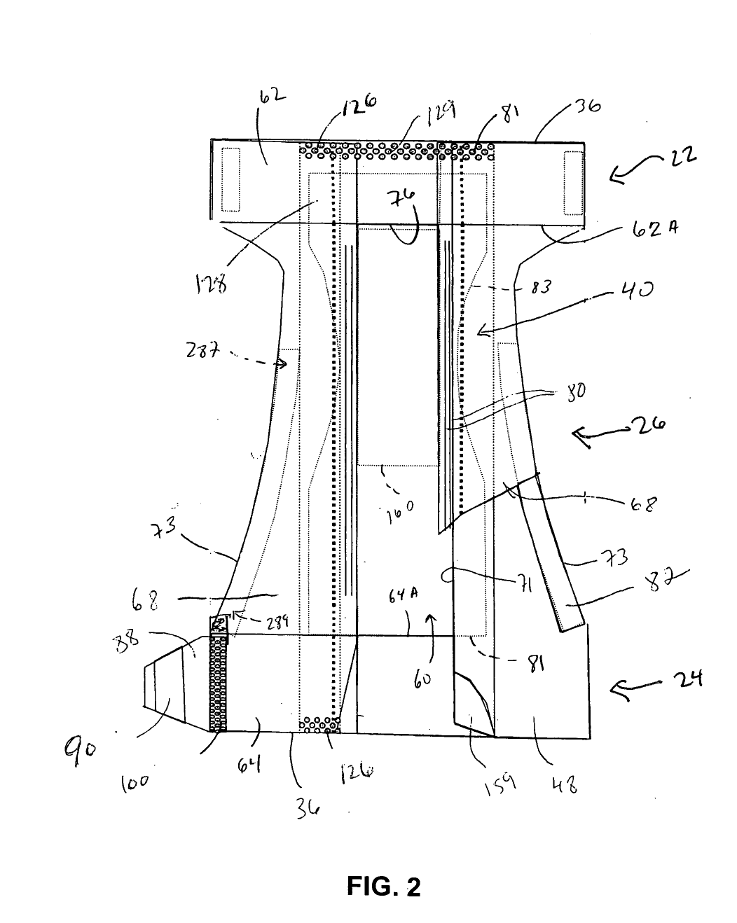

With reference now to the drawings and in particular to FIGS. 1 and 2, a disposable garment according to one embodiment of the present invention is described herein with reference to a disposable absorbent garment, and more particularly to a diaper, generally indicated at 20, intended to be worn about the waist and lower torso of an infant or toddler. It is understood, however, that the various aspects of the present invention are equally adaptable to other types of disposable garments such as adult incontinence garments, training pants, disposable swim pants and feminine hygiene garments. Disposable garments as referenced herein are intended for limited periods of use and are otherwise not intended for laundering. A disposable diaper, for example, is discarded after soiling by the wearer. Optionally, a disposable garment may include a replaceable absorbent insert wherein the remaining components of the garment may be reused several times before discarding.

The disposable diaper 20 of the illustrated embodiment generally has a front waist region 22, a back waist region 24, and a center region, otherwise referred to herein as a crotch region 26, extending longitudinally between and interconnecting the front and back waist regions. The front and back waist regions 22, 24 comprise those portions of the diaper 20 which, when worn, wholly or partially cover or encircle the waist and/or mid-lower torso of the wearer. The crotch region 26 generally is that portion of the diaper 20 which, when worn, is positioned between the legs of the wearer and covers the lower torso and crotch of the wearer.

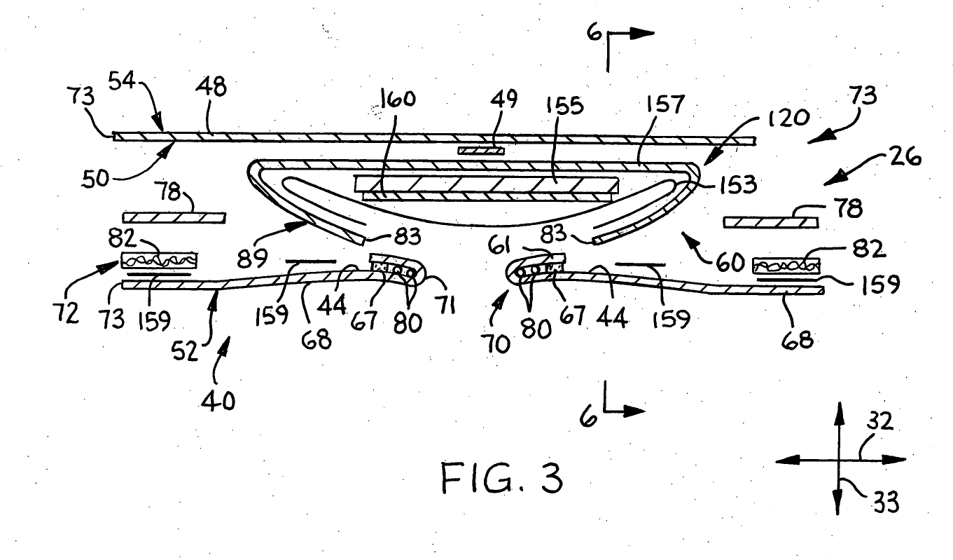

The diaper 20 has a longitudinal direction 30 and a lateral direction 32 thereof perpendicular to the longitudinal direction as indicated by the directional arrows provided in FIG. 1. The diaper also has a “z-direction” 33 (FIG. 3) which is generally normal to the longitudinal direction 30 and lateral direction 32. The various components of the diaper 20 described herein suitably define an inner surface 52 (FIG. 1) (otherwise referred to herein as a body-facing surface) which faces the wearer of the diaper and an outer surface 54 (FIG. 3) (otherwise referred to herein as a garment-facing surface) which faces away from the wear.

With further reference to FIG. 1, the diaper 20 also has a pair of laterally opposite side edges 34, and a pair of longitudinally opposite ends 36. The diaper 20 is illustrated in FIGS. 1 and 2 in an unfolded and laid flat (e.g., uncontracted) condition, similar to the configuration of the diaper prior to it being placed on the wearer. As worn, the diaper takes on a three-dimensional configuration (not shown) in which the side edges 34 of the diaper suitably define leg openings of the diaper 20 and the ends 36 together define a waist opening of the diaper 20.

The diaper 20 may be of various suitable shapes when unfolded and laid flat. For example, the diaper 20 may have an overall T-shape, hour-glass shape or a general I-shape as in the illustrated embodiment. Examples of diaper configurations suitable for use in connection with the instant application are described in U.S. Pat. No. 4,798,603 issued Jan. 17, 1989 to Meyer et al.; U.S. Pat. No. 5,176,668 issued Jan. 5, 1993, to Bernardin; U.S. Pat. No. 5,176,672 issued Jan. 5, 1993 to Bruemmer et al.; U.S. Pat. No. 5,192,606 issued Mar. 9, 1993 to Proxmire et al.; and U.S. Pat. No. 5,509,915 issued Apr. 23, 1996 to Hanson et al.; U.S. Ser. No. 11/215,978 filed Aug. 31, 2005 by VanGompel et al.; U.S. Ser. No. 11/118,619 filed Apr. 29, 2005 to Mullen et al.; and U.S. Ser. No. 10/735,978 filed Dec. 15, 2003 to Franke et al.; the disclosures of which are hereby incorporated by reference.

The illustrated diaper 20 (FIG. 3) suitably comprises an inner layer, generally indicated at 40, an outer layer, generally indicated at 48 in generally opposed (and more suitably superposed) relationship with the inner layer, and an absorbent assembly, generally indicated at 60, disposed between the inner and outer layers of the diaper for taking in and retaining body exudates released by the wearer. The inner layer 40 has an inner, or body-facing surface that at least in part defines the inner surface 52 of the diaper 20 and an outer, or garment-facing surface 44 (FIG. 3). The outer layer 48 (also commonly referred to as an outer cover) has an inner, or body-facing surface 50 (FIGS. 2 and 3) and an outer or garment-facing surface that defines the outer surface 54 of the diaper 20.

The inner layer 40 of the illustrated embodiment of FIG. 1 is suitably of a multiple component construction, and in particular comprises a front waist panel 62 (broadly, a first end panel of the inner layer) at least in part defining the front waist region 22 of the diaper 20 and a back waist panel 64 (broadly a second end panel of the inner layer) at least in part defining the rear waist region 24 of the diaper. The front and back waist panels 62, 64 are suitably longitudinally spaced from each other. For example, in the illustrated embodiment of FIG. 2 the front waist panel has a longitudinally outer end coterminous with the outer layer 48 to define a longitudinal end 36 of the diaper 20, and a longitudinally inner end 62A. The back waist panel 64 has a longitudinally outer end coterminous with the opposite end of the outer layer to define the opposite longitudinal end 36 of the diaper 20, and a longitudinally inner end 64A spaced longitudinally from the inner end 62A of the front waist panel so that the spacing therebetween at least in part defines the crotch region 26 of the diaper.

Referring to FIG. 2, the inner layer 40 further comprises a pair of laterally spaced side panels 68 that extend longitudinally through the crotch region 26 of the diaper 20, and more suitably extend from the front waist region 22 through the crotch region to the back waist region 24 of the diaper, and ever more suitably from one end 36 of the diaper 20 to the other end. Thus, it will be seen that the front and back waist panels 62, 64 and laterally spaced side panels 68 together define a central opening 76 of the inner layer 40 of the diaper 20 through which liquid, semi-liquid and solid exudates released by the wearer pass to the absorbent assembly 60. Each of the side panels 68 has a laterally inboard edge 71 and a laterally outboard edge 73. In the illustrated embodiment, the side edges of the front and back waist panels 62, 64 and the side edges of the outer layer 40 are coterminous and together define the lateral side edges 34 of the diaper 20 while the longitudinally inner ends 62A, 64A of the front and back waist panels 62, 64 and laterally inboard edges 71 of the side panels 68 together define the central opening 76 of the inner layer 40 of the diaper.

The side panels 68 are formed separate from the front and back waist panels 62, 64 and absorbent assembly 60 for subsequent assembly therewith. The side panels 68 are suitably constructed to be generally compliant, soft feeling, and nonirritating to the wearer's skin. In one suitable embodiment, each side panel 68 is stretchable (e.g., at least extensible), and is more suitably elastic, in the longitudinal direction 30 of the diaper 20.

As used herein, the term “stretchable” refers to a material that may be extensible or elastomeric. That is, the material may be extended, deformed or the like, without breaking, and may or may not significantly retract after removal of an extending force. The terms “elastomeric” or “elastic” are used interchangeably herein and refer to that property of a material where upon removal of an elongating force, the material is capable of recovering to substantially its unstretched size and shape or the material exhibits a significant retractive force. The term “extensible” refers to that property of a material where upon removal of an elongating force, the material experiences a substantially permanent deformation or the material does not exhibit a significant retractive force. In particular, elastomeric materials utilized in connection with the present invention may be elongated/extended or stretched in at least one direction without breaking by at least 25% (to at least 125% of its initial unstretched length) in at least one direction, suitably by at least 50% (to at least 150% of its initial unstretched length) and which will recover, upon release of the applied stretching or biasing force, at least 10% of their elongation. It is generally suitable that the elastomeric material or composite be capable of being elongated by at least 100%, more suitably by at least 200%, of its relaxed length and recover at least 30% and more suitably 50% of its elongation upon release of a stretching, biasing force, within about one minute.

Similarly, extensible or elongatable materials of the present invention may be capable of stretching in at least one direction without breaking by at least 25% (to at least 125% of its initial unstretched length) in at least one direction, suitably by at least 50% (to at least 150% of its initial unstretched length), more suitably by at least 100% (to at least 200% of its initial unstretched length). As an example, an extensible material having an initial unstretched length of 3 inches (7.6 centimeters) may be stretched without breaking to a stretched length of at least 3.75 inches (9.5 centimeters) in at least one direction (for the “by at least 25%” value).

In one suitable embodiment, illustrated in FIG. 1 each side panel 68 extends longitudinally from one longitudinal end 36 of the diaper 20 (i.e., the outer end of the front waist panel) to the opposite longitudinal end of the diaper (i.e., the outer end of the back waist panel). Accordingly, longitudinal end margins 75 of the side panels 68 generally underlie the front and back waist panels 62, 64 in the front and back waist regions 22, 24 of the diaper 20. The side panels 68 are suitably secured to the front and back waist panels 62, 64 along all or part of the end margins 75 of the side panels. More suitably, the side panels 68 are secured to the front and back waist panels 62, 64 from the laterally inboard edge 7 1, along each side panel end margin 75 that underlies the front and back waist panels, and to the laterally outward edge 73 of the outer cover in the region of end 36. In another embodiment (not shown) the side panels 68 may be secured to the front and back waist panels 62, 64 only across the longitudinally outer ends of the front and back waist panels corresponding to the longitudinal ends 36 of the diaper 20.

It is understood, however, that the side panels 68 need not extend to the longitudinal ends 36 of the diaper 20 to remain within the scope of this invention. For example, the side panels 68 may only be sized in length to underlie a portion of each of the front and back waist panels but otherwise terminate longitudinally inward of the ends 36 of the diaper 20. It is also contemplated that the side panels 68 may instead be sized in length to extend longitudinally into abutting (e.g., end-to-end) relationship with the longitudinally inner ends 62A, 64A of the front and back waist panels 62, 64 and be secured thereto without departing from the scope of this invention.

In another suitable embodiment, each side panel 68 is additionally stretchable (e.g., at least extensible), and may even be elastic, in the lateral direction 32 of the diaper 20. Providing lateral direction 32 stretchability to the side panel reduces the limiting effect that securing the side panel edge margins 75 to the front and back waist panels 62, 64 may have on the lateral stretch properties of the front and back waist panels. The lateral direction stretch capabilities of the side panel 68 also permit the side panel to stretch laterally during use at least along the longitudinal segment of the side panel extending between the longitudinally inner ends 62A, 64A of the front and back waist panels 62, 64, e.g., independent of the absorbent assembly, the outer layer and the front and back waist panels.

In the illustrated embodiment, each side panel 68 suitably comprises an elongate strip, such as a woven material, non-woven material, film or laminate comprised of one or more layers of such material. As an example, the side panels 68 may be suitably constructed of any of the materials from which a topsheet 153 or backsheet 157 of the absorbent assembly 60 may be constructed as described later herein. The side panels 68 are suitably constructed to be vapor permeable and liquid impermeable. However, the side panels 68 may alternatively be vapor and liquid impermeable, or vapor and liquid permeable, within the scope of this invention.

Each of the side panels 68 is suitably rendered elastic (e.g. elastomerically stretchable) in the longitudinal direction by securing one or more longitudinally extending elastic members along all or part of the length of the side panels. As an example, in the illustrated embodiment of FIG. 3, the elastic members in part comprise elastic strands 80 such as are known for use with containment flaps and waist elastics of conventional disposable garments such as diapers. In particular, one elastic member comprises a pair of elastic strands 80 extending longitudinally adjacent the laterally inboard edge 71 of the side panel 68. One or more elastic strands may be used. In addition, it is contemplated that one or more elastic bands (of greater width in the lateral direction 32) than thickness (in the z-direction) could be used instead of the substantially cylindrical-shaped bands shown in FIG. 3. The strip of material to which the elastic strands 80 are secured is folded over at the laterally inboard edge 71 of the side panel 68 to enclose the elastic strands therein. The elastic strands 80 suitably extend at least along the segment of the side panel 68 between the longitudinally inner ends 62A, 64A of the front and back waist panels 62, 64, but may extend along a greater or lesser extent of the length of the side panel. The elastic strands 80 (broadly, the elastic member) are suitably secured to the strip of material while the elastic strands are in a stretched condition.

Another elastic member of the side panel 68 comprises a single elastomeric band 82 extending longitudinally of the side panel in laterally spaced relationship with the elastic strands 80, and more suitably adjacent the laterally outboard edge 73 of the side panel 68. As illustrated in FIG. 3, the elastomeric band 82 is secured to the garment-facing side of the side panels 68 such that upon securement of the outboard edge 73 of the side panel 68 to the outer layer the band is coterminous. The elastomeric band 82 suitably extends longitudinally at least along the segment of the side panel 68 between the longitudinally inner end 64A of the back waist panel 64 and terminates in the crotch region 26. The elastomeric band 82 (broadly, the elastic member adjacent the outboard edge 73 of the side panel 68) is suitably secured to the bodyside 50 of the outerlayer 48 (or in the alternative, to side panel 68) while the elastomeric band is in a stretched condition. In the alternative, elastomeric band 82 extends beyond the crotch region 26 and into the front waist region 22.

With reference to FIG. 1, the diaper 20 may further comprise a pair of ears 88 that may be fastened to the opposite waist region as the diaper is placed about a wearer or prefastened as such. Suitably, the ears 88 are joined at the laterally opposite side edges of the chassis adjacent the back waist region 24. More suitably, each ear 88 has a longitudinal length equal the back elastic waist panel longitudinal length 84, and aligned and joined adhesively, ultrasonically, by thermal bond to opposite ends of the back elastic waist panel 64 at the outboard edge 73. Ears 88 may be any extensible or elastic non-woven material, or suitably, a nonextensible nonwoven. One suitable material is spunbond-meltblown-spunbond.

In one embodiment of the present invention, the leg elastics defined by the elastomeric band 82 are located within close vicinity of the rear waist panel, and in particular, where the ears 88 are attached to the rear waist panel at the outboard edge 73. Suitably, the bond area 86 used to attach ears 88 to back waist panel 64 is an ultrasonic or thermal bond that joins the ears 88 and rear waist panel 64 to the outer layer 48. Most suitably, the materials within the bond are rendered non-extensible. When the bond area is non-extensible, lateral outward forces applied to ear 88 are more effectively translated to not only the back waist panel 64, but to the back waist region 24. Further, a force applied to ear 88 in an outward lateral direction 32 and an outward longitudinal direction 30 will more effectively transmit force from ear 88 to the elastomeric band 82, providing that the elastomeric band 82 is in close vicinity to the bond area 86. This synergism between the ear 88, the back waist panel 64, the elastic band 82, and the pleated absorbent assembly 60, helps to conform the back waist region 24 about the wearer's hips as the wearer moves about. The synergistic effect is even more pronounced when the side panels 68 are constructed to also be stretchable in the lateral direction 32.

In one embodiment of the present invention, the leg elastic defined by elastomeric band 82 is in close vicinity to the bond area 86 when it has an end 289 that terminates within about 7 mm of the rear waist panel. In another embodiment of the present invention, the elastomeric band 82 is in close vicinity to the bond area 86 when it has an end 289 that terminates within about 4 mm of the rear waist panel. In yet another embodiment of the present invention, the elastomeric band 82 is in close vicinity to the bond area 86 when it has an end 289 that overlaps the rear waist panel. In a further embodiment of the present invention, the bond area 86 may extend beyond longitudinally beyond the edge of the back waist panel and overlap the end 289 of the elastomeric band 82.

In one embodiment of the invention, the elastomeric band 82 has a lateral width at end 289 that is wider than the opposite end 287. In another embodiment of the invention, the elastomeric band 82 is tapered such that the lateral width of the end 289 is wider than the opposite end thereof (see, FIG. 1). In yet another embodiment, the elastic band 82 has a uniform width along its longitudinal length (see, FIG. 2).

While the elastic members are illustrated in FIG. 3 as comprising one or more elastic strands 80, and a single elastic band 82, it is contemplated that the elastic members may be other than elastic bands, such as elastic strands or other suitable elastic members, without departing from the scope of this invention. It is further understood that the stretchability and elasticity of the elastic member adjacent the inboard edge 71 of the side panel 68 may be different from the stretchability and elasticity of the elastic member adjacent the outboard edge 73 of the side panel.

The front and back waist panels 62, 64 of the inner layer 40 are suitably compliant, soft feeling, and nonirritating to the wearer's skin. The waist panels 62, 64 may have any suitable shape, such as rectangular (e.g., the front and back waist panel of the illustrated embodiment), trapezoidal or otherwise non-rectangular depending on the desired overall shape of the diaper 20. One or both of the front and back waist panels 62, 64 may extend laterally outward beyond laterally outboard edges 73 of the connecting members 68 and remain within the scope of this invention. Most suitably, the side edges of the front and back waist panels 62, 64 may be coterminous with the laterally outboard edges 73 of the connecting members 68.

The front and back waist panels 62, 64 may be suitably constructed to be vapor and liquid permeable, vapor permeable but liquid impermeable, or vapor and liquid impermeable. For example, the front and back waist panels 62, 64 may be suitably constructed of any of the liquid permeable materials from which a topsheet 153 of the absorbent assembly 60 is constructed as described later herein.

In particularly suitable embodiments, the front and back waist panels 62, 64 are also suitably stretchable, and are more suitably elastic (i.e., elastomerically stretchable) in at least the lateral direction of the diaper 20 to provide a retractive force about the waist of the diaper wearer. It is contemplated that the front and back waist panels 62, 64 may also be stretchable, and may even be elastic, in the longitudinal direction of the diaper.

Various materials may be used to construct the stretchable front and back waist panels 62, 64. For example, in one suitable embodiment each of the panels 62, 64 are elastic and comprise a three ply laminate such as a Stretch Bonded Laminate (SBL) that consists of two nonwoven facings attached to an elastic inner layer while the inner layer is in a stretched condition. One such suitable SBL material is disclosed in U.S. Pat. No. 4,657,802 to Morman, incorporated by reference herein.

Another suitable embodiment of the elastic panels 62, 64 is a Necked Bonded Laminate (NBL) that is also a three-ply laminate but the elastic inner layer is not prestretched prior to attaching the two nonwoven facings. For the NBL, the nonwoven facings are necked stretched and the elastic inner layer is attached between the necked facings. Other suitable elastically stretchable NBL materials as are described in U.S. Pat. No. 5,226,992 issued on Jul. 13, 1993 to Morman, the disclosure of which is hereby incorporated by reference.

In other embodiments the panels 62, 64 may be formed from elastically stretchable film materials. Such films may be elastic in the lateral direction, the longitudinal direction or both. One suitable elastic film is a breathable elastic film as described in U.S. patent application Ser. No. 10/703,761 filed on Nov. 7, 2003 and titled “Microporous Breathable Elastic Films, Methods of Making Same, And Limited Use or Disposable Product Applications,” the disclosure of which is hereby incorporated by reference. Use of such breathable, elastic films may provide additional benefits for the skin health of the wearers of the garments of the invention.

Additional examples of suitable breathable elastic film laminates for use in constructing the front and back waist panels 62, 64 are described in Provisional U.S. Patent Application Ser. No. 60/518,100 filed on Nov. 7, 2003 and titled “Microporous Breathable Elastic Film Laminates, Methods of Making Same, and Limited Use or Disposable Product Applications,” the disclosure of which is hereby incorporated by reference. Other suitable elastic laminates are described in U.S. patent application Ser. No. 10/743,245 filed on December 22, 2003 and titled “Extensible and Stretch Laminates and Method of Making Same,” the disclosure of which is hereby incorporated by reference.

Other suitable elastic nonwoven materials from which the front and back waist panels 62, 64 may be constructed include elastomeric materials that are treated using nonwoven manufacturing processes such as meltblowing. Suitable elastomers that may be formed into microfibers/nonwoven webs are described in U.S. Pat. No. 4,663,220 issued to Wisneski et al. on May 5, 1987 and titled “Polyolefin-Containing Extrudable Compositions and Methods for Their Formulation Into Elastomeric Products Including Microfibers,” the disclosure of which is hereby incorporated by reference. Meltblowing of KRATON copolymers (“KRATON” is a trade designation of the Shell Chemical Company) to form composite nonwoven elastic webs is described in U.S. Pat. No. 4,657,802 issued to Morman on Apr. 14, 1987 and titled “Composite Nonwoven Elastic Web,” the disclosure of which is hereby incorporated by reference.

With particular reference to FIGS. 2 and 3, the absorbent assembly 60 has longitudinally opposite ends 81 and laterally opposite side edges 83, and is disposed below the central opening 76 of the inner layer 40, e.g., in the crotch region 26 of the diaper 20, to receive body exudates that pass through the inner layer. The absorbent assembly 60 is suitably sized in length to be about equal to the overall length of the diaper 20. The absorbent assembly 60 is also suitably sized in width to be slightly narrower than the overall width of the diaper 20 at the crotch region 26, but to otherwise extend laterally at least up to and more suitably laterally outward of the laterally inboard edges 71 of the side panels 68 (e.g., sized as wide as and more suitably wider than the central opening of the inner layer.

The illustrated absorbent assembly 60 suitably comprises the topsheet 153, the backsheet 157 and an absorbent structure 155 disposed therebetween for taking in and retaining liquid body exudates (e.g. urine where the garment is the diaper 20). In particular, the topsheet 153 and backsheet 157 are suitably in opposed, generally coextensive relationship with each other so that they together define longitudinal ends 81 and lateral side edges 83 of the absorbent assembly. It is contemplated, however, that the topsheet 153 and backsheet 157 need not be coextensive, e.g., one may be longer and/or wider than the other to singly define the longitudinal ends 81 and/or lateral side edges 83 of the absorbent assembly 60 without departing from the scope of this invention.

The topsheet 153 of the absorbent assembly 60 suitably defines an inner or body-facing surface of the absorbent assembly that is compliant, soft feeling, and nonirritating to the wearer's skin since it is exposed to the wearer's skin through the central opening 76 of the inner layer 40. Further, the topsheet 153 may be less hydrophilic than the absorbent structure 155, and is sufficiently porous to be liquid permeable so that liquid body exudates can readily penetrate through the topsheet to the absorbent structure 155. The topsheet 153 may be suitably formed from a wide selection of web materials, such as porous foams, reticulated foams, apertured plastic films, natural fibers (for example, wood or cotton fibers), synthetic fibers (for example, polyester or polypropylene fibers), or a combination of natural and synthetic fibers.

In particular, various woven and nonwoven fabrics may be used for the topsheet 153. For example, the topsheet 153 may be formed of a meltblown or spunbond web of polyolefin fibers. The topsheet layer 153 may also be a bonded-carded web composed of natural and/or synthetic fibers. The topsheet 153 may be composed of a substantially hydrophobic material, and the hydrophobic material may, optionally, be treated with a surfactant or otherwise processed to impart a desired level of wettability and hydrophilicity. As one example, the topsheet layer 153 may suitably comprise a nonwoven, spunbond, polypropylene fabric composed of about 2.8-3.2 denier fibers formed into a web having a basis weight of about 22 grams per square meter and a density of about 0.06 grams per cubic centimeter. The web can be treated with a suitable surfactant, such as about 0.28% Triton X-102 surfactant, which may be applied by any conventional means such as spraying, printing, brush coating or the like.

The backsheet 157 is suitably constructed to be liquid impermeable and may or may not be vapor permeable. For example, the backsheet 157 may be formed from a thin plastic film or other flexible liquid-impermeable material. In a more particular example, the backsheet 157 may be formed from a polyethylene film having a thickness of from about 0.013 millimeter (0.5 mil) to about 0.051 millimeter (2.0 mils). The backsheet 157 may also be formed from a polyolefin film having a nonwoven web laminated to the exterior surface thereof, such as a spunbond web of polyolefin fibers. For example, a stretch-thinned polypropylene film having a thickness of about 0.015 millimeter (0.6 mil) may be thermally laminated to a spunbond web of polypropylene fibers having a fiber diameter of about 15 to 20 microns, with the nonwoven web having a basis weight of about 17 grams per square meter (0.5 ounce per square yard). The backsheet 157 may in some embodiments include bicomponent fibers such as polyethylene/polypropylene bicomponent fibers. The backsheet 157 may also include a vapor permeable non-woven facing layer laminated to a micro-porous film to impart “breathability” to the barrier layer. Suitable “breathable” barrier layer 157 materials are described in U.S. Pat. No. 5,695,868 issued Dec. 9, 1997 to McCormack et al. and U.S. Pat. No. 5,843,056 issued Dec. 1, 1998 to Good et al., the disclosures of which are incorporated by reference to the extent they are consistent herewith.

The backsheet 157 may also be constructed of any of the materials disclosed later herein from which the outer layer 48 of the diaper 20 may be constructed. While the backsheet 157 may even be constructed of the same material as the outer layer 48, it is contemplated that the backsheet 157 and outer layer 48 may be constructed of different materials and remains within the scope of this invention. In particular, for example, the backsheet 157 need not have a non-woven or otherwise soft-textured outer surface because it is substantially covered by the outer layer 48 of the diaper 20 and therefore unexposed exterior of the diaper. Other suitable backsheet 157 constructions are disclosed in U.S. Pat. No. 6,217,563 (Van Gompel et al.), the disclosure of which is incorporated by reference to the extent it is consistent herewith. The backsheet 157 may optionally be stretchable, and may further optionally be elastic.

The absorbent structure 155 of the absorbent assembly 60 may suitably comprise a matrix of hydrophilic fibers, such as a web of cellulosic fluff, and may optionally further comprise a high absorbency material commonly known as superabsorbent material. For example, the absorbent structure 155 may include a matrix of cellulosic fluff, such as wood pulp fluff, and superabsorbent hydrogel-forming particles. The wood pulp fluff may be exchanged with synthetic, polymeric, meltblown fibers or with a combination of meltblown fibers and natural fibers. The superabsorbent particles may be substantially homogeneously mixed with the hydrophilic fibers or may be nonuniformly mixed. Alternatively, the absorbent structure 155 may include a laminate of fibrous webs and superabsorbent material or other suitable matrix for maintaining a superabsorbent material in a localized area. The size and the absorbent capacity of absorbent structure 155 should be compatible with the size of the intended wearer and the liquid loading imparted by the intended use of the garment. Further, the size and the absorbent capacity of the absorbent structure 155 can be varied to accommodate disposable absorbent garment wearers ranging from infants through adults.

The high-absorbency material may be selected from natural, synthetic, and modified natural polymers and materials. The high-absorbency materials may be inorganic materials, such as silica gels, or organic compounds, such as crosslinked polymers. The term “crosslinked” refers to methods for effectively rendering normally water-soluble materials substantially water insoluble but swellable. Such methods include, for example, physical entanglement, crystalline domains, covalent bonds, ionic complexes and associations, hydrophilic associations such as hydrogen bonding, and hydrophobic associations or Van der Waals forces. Examples of synthetic, polymeric, high-absorbency materials include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinyl morpholinone), poly(vinyl alcohol), and mixtures and copolymers thereof. Further polymers suitable for use in the absorbent structure 155 include natural and modified natural polymers, such as hydrolyzed acrylonitrile-grafted starch, acrylic acid grafted starch, methyl cellulose, carboxymethyl cellulose, hydroxypropyl cellulose, and the natural gums, such as alginates, xanthan gum, locust bean gum, and the like. Mixtures of natural and wholly or partially synthetic absorbent polymers may also be useful. The high absorbency material may be in any of a wide variety of geometric forms. As a general rule, the high absorbency material is in the form of discrete particles. However, the high absorbency material may also be in the form of fibers, flakes, rods, spheres, needles, or the like.

In general, the high-absorbency material is suitably present in the absorbent structure 155 in an amount from about 5 to about 90 percent by weight, more suitably in an amount of at least about 30 percent by weight, and even more suitably in an amount of at least about 50 percent by weight based on a total weight of the absorbent structure 155. For example, in a particular aspect, the absorbent structure 155 may comprise a laminate which includes at least about 50 percent by weight and more suitably at least about 70 percent by weight of high-absorbency material overwrapped by a fibrous web or other suitable material for maintaining the high-absorbency material in a localized area. An example of high-absorbency material suitable for use in the present invention is DRYTECH 2035 polymer available from Dow Chemical, a business having offices in Midland, Mich. Other suitable superabsorbents may include FAVOR SXM 880 polymer obtained from Stockhausen, a business having offices in Greensboro, N.C.

The absorbent structure 155 may further comprise a wrapsheet (not shown) at least covering the body-facing surface of the fibrous matrix, and more suitably enclosing the matrix in the wrapsheet. Alternatively, the wrapsheet may cover both the body-facing surface and the garment-facing surface of the matrix but not the sides of the matrix. The wrapsheet is suitably comprised of an absorbent material, or at least a liquid permeable material. For example, a suitable wrapsheet may comprise a meltblown web composed of meltblown fibers, such as meltblown polypropylene fibers. Another example of a suitable wrapsheet may comprise a low porosity cellulosic web, such as a tissue web composed of an approximately 50/50 blend of hardwood/softwood fibers.

With reference to FIGS. 2 and 3, the absorbent assembly 60 may further include a surge management layer 160 positioned between the topsheet 153 and the absorbent structure 155 to quickly take in and efficiently distribute liquid exudates to the absorbent structure 155. Suitable constructions and arrangements of surge management layers are well known to those skilled in the art. The surge management layer 160 is sized narrower than the width of the absorbent structure 155 and is sized substantially shorter than the length of the absorbent structure. The surge layer 160 is suitably positioned longitudinally nearer to the front end of the absorbent assembly where initial insults occur.

As illustrated in FIG. 3, the topsheet 153 and backsheet 157 of the absorbent assembly 60 may extend laterally beyond the side edges of the absorbent structure 155 to the side edges 83 of the absorbent assembly 60. That is, the width of the absorbent structure is less than the width of the topsheet 153 and/or backsheet 157 so that the side edges 83 of the absorbent assembly 60 are disposed laterally outward of the side edges of the absorbent structure. In particular embodiments, the topsheet 153 and backsheet 157 are suitably secured to each other along the longitudinal ends 81 and lateral side edges 83 of the absorbent assembly 60 by adhesive bonding, ultrasonic bonding, thermal bonding or other suitable securement technique. The topsheet 153 may be secured directly to the backsheet 157 as in the illustrated embodiment or indirectly, such as by an intermediate component.

The laterally outward extensions of the topsheet 153 and/or the backsheet 157 are suitably C-folded as illustrated in FIG. 3 such that lateral edge margins 89 of the absorbent assembly 60 (e.g., a lateral region at and/or adjacent to the side edges 83 of the absorbent assembly), and more suitably the garment-facing surface thereof, are in opposed relationship with the inner layer 40 of the diaper 20 for attachment thereto as will be described later herein. In particular, the outer or garment-facing surface of the absorbent assembly 60 at the lateral edge margins 89 thereof (e.g., the outer surface of the backsheet 157) are in opposed relationship with and secured to the outer or garment-facing surface 44 of the inner layer 40 and more suitably the side panels 68 of the inner layer. It is contemplated that the lateral extensions of the topsheet 153 and/or the backsheet 157 may instead be Z-folded or folded in another suitable manner which allows subsequent unfolding, or expansion, of the lateral extensions during loading of the absorbent assembly 60. It is also contemplated that the lateral extensions of the topsheet 153 and/or backsheet 157 may be folded such that the inner or body-facing surface of the absorbent assembly at the lateral edge margins 89 thereof are in opposed relationship with and secured to the garment-facing surface 44 of the inner layer 40.

The lateral extensions of the topsheet layer 153 and the barrier layer 157 allow the absorbent assembly 60 to expand in the z-direction 33 (FIG. 3) upon loading of the absorbent structure 155. The lateral extensions also allow for lateral expansion of the absorbent assembly 60 upon lateral elongation of the inner layer opening 76, such as where the front and back waist panels 62, 64 are stretched laterally and thus move the side panels 68 further apart.

With particular reference to FIG. 3, the lateral edge margins 89 of the absorbent assembly 60 are suitably secured to the side panels 68 by adhesive 159. The adhesive 159 may be applied as a uniform continuous layer of adhesive, a patterned layer of adhesive, a sprayed pattern of adhesive, an array of separate lines, swirls or dots of adhesive, or any other pattern of adhesive. It is understood that the lateral edge margins 89 of the absorbent assembly 60 may alternatively or additionally be secured to the side panels 68 by ultrasonic bonding, thermal bonding or other suitable securement techniques.

The absorbent assembly 60 is also suitably secured along its longitudinal ends to the respective front and back waist panels 62, 64. The securement or bonding of absorbent assembly 60 along its longitudinal ends to the respective front and back waist panels 62, 64 is achieved by a bond means. The “bond means” is a structure that carries out the function of permanently bonding together the absorbent assembly 60 to other portions of the garment such as the front and back waist panels 62, 64; the outer layer 48 and/or the flap portions of side panels 68. Regardless of the particular embodiment of the invention, the term “permanent” used in conjunction with “bond” is meant to define a securement of one or more materials and/or layers of like materials, which is not intended to become unsecured or separate during the donning and wearing of the garment.

Limited bond means is a structure that carries out the function of bonding together the flap portion of a side panel 68 to the front or back waist panels 62, 64, without also bonding the side panel to the topsheet 153.

One possible bond structure used for the bond means or limited bond means is a material-to-material bond where the materials are fused together via exposure to heat or activity that causes heating, e.g. ultrasonic waves or pressure. Another possible bond structure includes the use of external devices such as adhesives, stitches, staples, rivets, and the like. Material-to-material bonds may be combined or used in combination with external devices. For instance an adhesive may be used in combination with an ultrasonic or thermal bond.

The bond means or limited bond means, whether a material-to-material bond or one created by external devices, may include a bond pattern. For instance, material-to-material bonds or adhesive bonds may cover an entire bond zone 126 continuously, or non-continuously, such as with a random or nonrandom array of bond points, stripes, and/or swirls. More specifically, the adhesive 78 may be applied as a uniform continuous layer of adhesive, a patterned layer of adhesive, a sprayed pattern of adhesive, an array of separate lines, swirls or dots of adhesive, or any other pattern of adhesive. Likewise, the material-to-material bonds may be applied as a uniform continuous bond area, a patterned bond area, an array of separate lines, swirls or dots of bond area, or any other pattern of bond area.

The bond means may be limited to a first bond zone 126. The first bond zone 126 is an area wherein bonding occurs between each and every layer in the z-direction of the garment 20. Any stretchability that would occur within the first bond zone when the layers were in an unbonded state would be greatly reduced, possibly so that no extensibility would occur within the first bond zone 126. For example, in FIG. 1, the first bond zone 126 bonds together the elastic waist panels 62, 64; the outer layer 48; one of the flap portions 70; and one of the absorbent assembly lateral side folds or pleats 120. In one embodiment, the first bond zone is located adjacent the waist opening, and may coincide with the edge at end 36.

The limited bond may be limited to a second bond zone 128. The second bond zone 128 is an area where one of the elastic waist panels 62, 64; one of the flap portions 70, and one of the absorbent assembly lateral side folds or pleats 120 are bonded together without bonding any of these components to the rest of the absorbent assembly 60 or outer layer 48. Suitably, the second bond zone 128 is located directly adjacent the first bond zone 126, and aligned in the longitudinal direction 30 therewith.

Except for bond zone 126 and the bond region 129 that laterally separates bond zones 126; the absorbent assembly 60 is otherwise free from securement to the front and back waist panels 62, 64 laterally between the side panels 68 particularly along the longitudinally inner ends 62A, 64A of the waist panels. In this manner, the front and back waist panels 62, 64 and the absorbent assembly 60 together form longitudinally opposite pockets during wear (e.g., that open longitudinally inward of the diaper 20) for collecting liquid, semi-liquid and solid exudates.

As further discussed herein, the side panels 68 and the outer layer 48 are stretchable in the lateral direction so that the attachment of the side panels to the outer layer does not inhibit the stretchability of either the side panels or the outer layer. Further, the laterally inboard edge 71 of the side panels 68 is free from attachment to the outer layer 48 so that the inboard edge of the side panels is positionable relative to and independent of the outer layer.

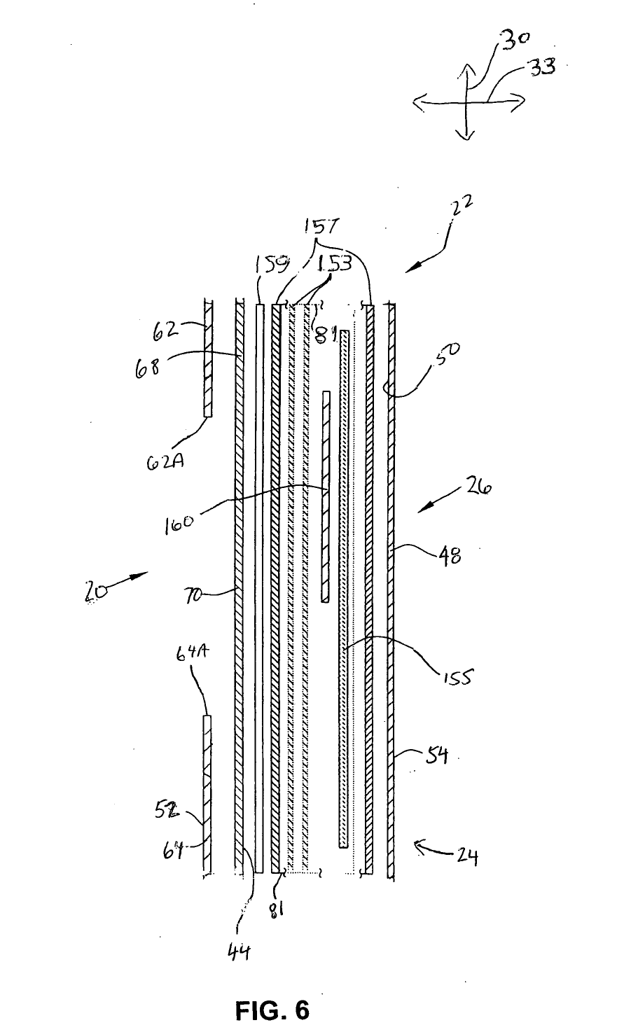

In a particularly suitable embodiment such as that illustrated in FIGS. 3 and 6, the lateral edge margins 89 of the absorbent assembly 60 are secured to the garment-facing surface of side panels 68 along a line of attachment, e.g., defined by the adhesive 159 in the illustrated embodiment, that extends generally longitudinally of the side panels along the entire length of the side panels. The line of attachment is suitably disposed laterally between the inboard and outboard edges 71, 73 of the side panel 68.

By keeping the first bond zone 126 relatively short in the longitudinal direction, the hip width 14a may increase to conform to the wearer's movements. For instance, a length of about 4 mm to about 25 mm may be desirable. In another embodiment, a length of about 4 mm to about 15 mm may be desirable. In yet another embodiment, a length of about 4 mm to about 10 mm may be desirable. The shorter the distance, the more easily the front waist region 22 and/or back waist region can expand and conform to a wearer's movements.

Because the inboard edges 71 of the side panels 68 are otherwise unsecured to the outer layer or other components of the diaper 20, the inboard edges of each side panel along such a segment are also positionable relative to and independent of the outer layer and the front and back waist panels. The outboard edges 73 of the side panels 68 are secured to the front and back waist panels 62, 64 at least along the segment of the side panels extending between the inner ends 62A, 62B of the waist panels. The outboard edges of each side panel along such a segment are also positionable relative to and independent of the front and back waist panels.

Thus, when a lateral force is applied to the elastic waist panels 62, 64, the back waist region 24 (adjacent the crotch region 26), as well as crotch region 26, is free to move laterally outward (outboard) in direction 32. To determine how far a pleated component may extend in the lateral direction 32, the following equation may be used. The final waist width 12 (Ww) is the maximum crotch width or hip width 14 (Hw) reduced by the number of folds or pleats times two, multiplied by the fold width.

Ww=Hw−(folds×2)×fold width

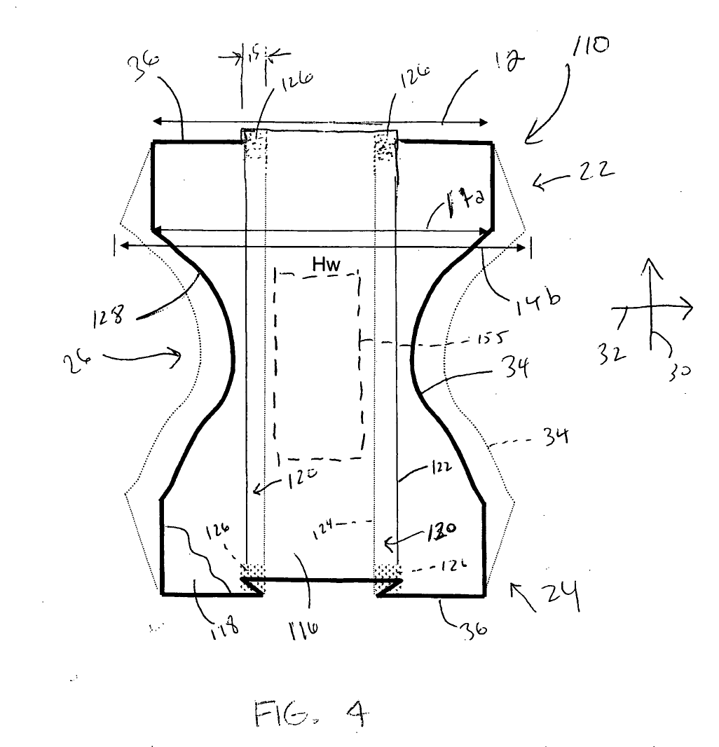

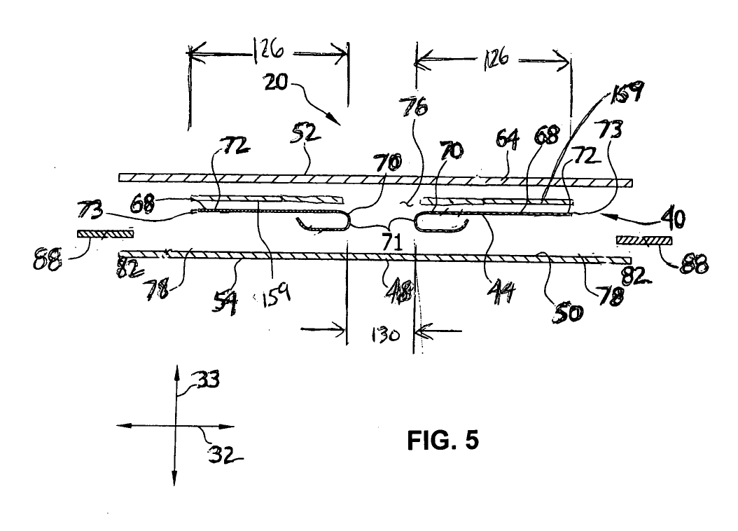

For example, a garment 20 that has a hip width (Hw) of 30 cm and two 3 cm folds at the waist region 22, has a front waist width 12 equaling 18 cm. (See FIG. 4 showing an embodiment of the invention demonstrating the waist and hip width.)

Referring to FIG. 3, the line of attachment between each side panel 68 and the edge margin 89 of the absorbent assembly 60 generally defines a laterally inner portion 70 or flap portion of the side panel between the line of attachment 159 and the inboard side edge 71 of the side panel, and a laterally outer portion 72 or leg cuff portion of the side panel between the line of attachment and the outboard side edge 73 of the side panel. In this manner, during wear the inner portion 70 of each side panel 68 broadly defines a containment flap along at least the longitudinal segment of the side panel between the longitudinally inner ends 62A, 64A of the front and back waist panels 62, 64. In particular, the containment flaps are oriented laterally inward and generally upright in the crotch region 26 to inhibit the lateral flow of body exudates out of the diaper 20. The outer portions 72 of the side panels 68 broadly define leg cuffs that are oriented laterally outward and generally downward to gasket about the wearer's legs to thereby reduce leakage and provide improved comfort and appearance.

Because the side panels 68 are generally hinged to the expandable absorbent assembly 60, upon wearing of the diaper 20 the containment flap portion (e.g., laterally inner portion 70) of the side panel is able to freely move relative to the absorbent assembly, the front and back waist panels 62, 64 and outer layer 48 up to its generally upright orientation at the crotch of the wearer while the leg cuff portion (e.g., laterally outer portion 72) of the side panel is able to freely move relative to the absorbent assembly and the front and back waist panels 62, 64 to a lower position nearer the thigh of the wearer.

In the illustrated embodiment of FIG. 3, the absorbent assembly 60 may be constructed to be generally free from securement to the outer layer 48 of the diaper 20. However, a more suitable embodiment shows a laterally central region of the absorbent assembly (e.g., laterally between the side edges of the absorbent structure 155) may be secured to the inner or body-facing surface 50 of the outer layer 48 by an adhesive 49 without departing from the scope of this invention (see FIG. 3).

The outer layer 48 is suitably extensible in at least the lateral direction in accordance with the lateral stretchability of the side panels 68, as shown in FIG. 3, in which the outer portion 72 of each side panel is secured to the outer layer. The outer layer 48 is also suitably soft-feeling, compliant and “breathable” or vapor permeable material. As an example, an extensible outer layer 48 can be composed of a necked fabric, a creped fabric, a micro-pleated fabric, polymer films or the like, as well as combinations thereof. The fabrics may be woven or nonwoven materials, such as spunbond fabrics. An example of a suitable extensible outer layer material is a 60% necked, polypropylene spunbond having a basis weight of about 1.2 osy.

For the purposes of the present disclosure, the term “% necked” or “percent neckdown” refers to a ratio or percentage determined by measuring the difference between the pre-necked dimension and the necked dimension of a neckable material, and then dividing that difference by the pre-necked dimension of the neckable material. The percentage of necking (percent neck) can be determined in accordance with the description in the above-mentioned U.S. Pat. No. 4,965,122 entitled REVERSIBLE NECKED MATERIAL AND PROCESS TO MAKE IT, by M. T. Morman which was issued Oct. 23, 1990 and is incorporated by reference herein.

Alternatively, the outer layer 48 of the diaper 20 may be suitably constructed to be liquid impermeable. For example, in one embodiment the outer layer 48 may be comprised of a thin plastic film or other flexible liquid-impermeable material. A particularly suitable outer layer 48 material is a polyethylene film having a thickness of from about 0.012 millimeter (0.5 mil) to about 0.051 millimeter (2.0 mils). To present such an outer layer 48 with a more clothlike feeling, the outer layer 48 may further comprise a polyolefin film having a nonwoven web laminated to the outer surface thereof, such as a spunbond web of polyolefin fibers. For example, a stretch-thinned polypropylene film having a thickness of about 0.015 millimeter (0.6 mils) may have thermally laminated thereto a spunbond web of polypropylene fibers having a thickness of about 1.5 to 2.5 denier per filament, with the nonwoven web having a basis weight of about 17 grams per square meter (0.5 ounce per square yard). Methods of forming such clothlike outer layers are known to those skilled in the art. Alternatively, or additionally, the outer layer 48 may be formed of a woven or nonwoven fibrous web that has been totally or partially constructed or treated to impart a desired level of liquid impermeability to selected regions that are adjacent or proximate to the absorbent assembly 60.

In other embodiments, the outer layer 48 may be suitably constructed to be permeable to water vapor and have a water vapor transmission rate (WVTR) of at least about 1000 g/m2/24 hours, more suitably at least about 1500 g/m2/24 hours, even more suitably at least about 2000 g/m2/24 hours, and still more at least about 3000 g/m2/24 hours. Materials which have a water vapor transmission rate less than those above do not allow a sufficient amount of air exchange and undesirably result in increased levels of skin hydration. A suitable technique for determining the WVTR value of a material is the test procedure standardized by INDA (Association of the Nonwoven Fabrics Industry), number IST-70.4-99, which is incorporated by reference herein. The testing device which may be used for WVTR measurement is known as the Permatran-W Model 100K manufactured by Mocon/Modem Controls, Inc., with an office in Minneapolis, Minn.

In another suitable embodiment, the outer layer 48 may comprise a microporous film/nonwoven laminate material comprising a spunbond nonwoven material laminated to a microporous film. For example, the laminate may include a 0.6 osy (20.4 gsm) polypropylene spunbond material thermally attached to an 18.7 gsm stretched microporous film. The film may include from about 20 percent to about 75 percent by weight calcium carbonate particulates and the remainder primarily low density polyethylene. The film is then stretched which causes the polyethylene component to stretch while the particulates remain unstretched, thus causing voids to develop around the calcium carbonate particles in the film. The resulting laminate may define a water vapor transmission rate of from about 1000 to about 5000 g/m2/24 hours.

The outer layer 48 of the diaper 20 is preferably formed from a stretchable material so as to be extensible or even elastic to facilitate stretching of the outer layer along with the inner layer 40 of the diaper 20 as well as the side panels 68 (where the side panels are secured to the outer layer such as in the embodiment of FIG. 3). When the outer layer 48 is formed of a stretchable material, the outer layer is suitably capable of stretching in at least the lateral direction 32 and may additionally be stretchable in the longitudinal direction 30. It is contemplated that where the outer layer 48 is stretchable in both directions, it may be extensible in both directions, elastic in both directions, or extensible in one direction and elastic in the other direction.

With further reference to FIG. 1, the diaper 20 may further comprise a pair of fastener tabs 90 employed on the ears 88 to secure the diaper about the waist of a wearer. Suitable fastener tabs 90 include hook-and-loop type fasteners, adhesive tape fasteners, buttons, pins, snaps, mushroom-and-loop fasteners, and the like. In the illustrated embodiment the fastener tabs 90 are secured between the outer layer 48 and the back waist panel 64 at the side edges of the diaper 20 by ultrasonic bonds or the like and extend laterally outward therefrom. Cooperating fasteners 92 may be provided on the outer layer 48 in the front waist region 22 of the diaper. Alternatively, the outer layer 48 may be constructed of a material to which the fastener tabs 90 may be suitably fastened.

With reference now to the drawings and in particular to FIG. 4, a disposable garment according to another embodiment of the present invention is described. In one embodiment of the present invention as shown in FIG. 4, there is a relatively simple disposable garment 110 for wearing about the lower torso of a person. As with the previous embodiment, the garment defines a longitudinal direction 30, a lateral direction 32, lateral side edges 34, front and back longitudinal ends 36; each of the ends having a waist width 14a between the lateral side edges 34. The garment has a front waist region 22, a back waist region 24, and a crotch region 26 extending longitudinally between and interconnecting the front waist region 22 and the back waist region 24. When the garment 110 is folded in about half at the crotch region 26, ends 36 may be joined to form a waist opening.

Disposable garment 110 may be constructed from either a single layer of material or multiple layers. In one embodiment, garment 110 is constructed from an outer layer 118 in opposed relationship with an inner layer 116. The inner and outer layers 116, 118 may be of the same size, or of different sizes. Further, the inner and outer layers 116, 118 may be aligned so that one or more of the ends 36 or side edges 34 are in alignment, as described in the previous embodiment. The inner and outer layers 116, 118 may be laminated together to form a single member, or remain separated over the majority of the surface area defined by the layers.

One or more pleats 120 may be formed in the garment by longitudinally folding the inner layer 116 and/or the outer layer 118 along the length of the garment 110 along fold lines 122 and 124. A single C-fold may be used as depicted; other fold configurations (e.g. Z-folds) may be made by adding additional fold lines adjacent the depicted fold lines 122 and 124. In addition, more pleats may be created across the waist width 12. For instance, there may be a total of three, four, five, six pleats, or more, as desired.

The waist width 12 is fixed by bonding the pleats 120 in at least a bond zone 126 adjacent the end 36. The purpose of bond zone 126 is to permanently join the inner and/or outer layers 116, 118 at the waist to form a permanent pleat so that a relative increase in hip width 14a can occur. This increase in width may occur regardless of whether the inner layer 116 and outer layer 118 are stretchable or elastic. However, the stretchability or elasticity of the materials may enhance the garment's ability to conform to a wearer. In addition, if only one of two or more layers includes one or more pleats 120, it is desirable that the non-pleated layer be at least stretchable so as not to prevent the pleated layer from expanding at the hip.

By keeping the bond zone 126 relatively short in the longitudinal direction, the hip width 14a may increase to conform to the wearer's movements. For instance, a length of about 4 mm to about 25 mm may be desirable. In another embodiment, a length of about 4 mm to about 15 mm may be desirable. In yet another embodiment, a length of about 4 mm to about 10 mm may be desirable. The shorter the distance, the more easily the front waist region 22 and/or back waist region can expand and conform to a wearer's movements.

Most desirably, a bond zone 126 acts to prohibit stretch in the area of the bond zone. For instance, if the inner and outer layers 16, 18 are stretchable or elastic, the waist width 12 will be prohibited from expanding in two ways: by the pleat structure, and by the lack of stretchability in the bond zone 126. By contrast, the garment is relatively uninhibited in its ability to expand provided that the bond zone is short enough so as not to prohibit the pleats 120 from unfolding across the hip width 14a. Thus, the hip width 14a may expand to hip width 14b when a lateral force is applied to the front or back waist region, as depicted in FIG. 4.

The embodiment of FIG. 4 may be enhanced by adding ears, fasteners, and absorbent assembly, or other features typical for a disposable absorbent product, as described herein for the previous embodiment. For example, an absorbent structure 155 may be placed between the inner and outer layers 116, 118.

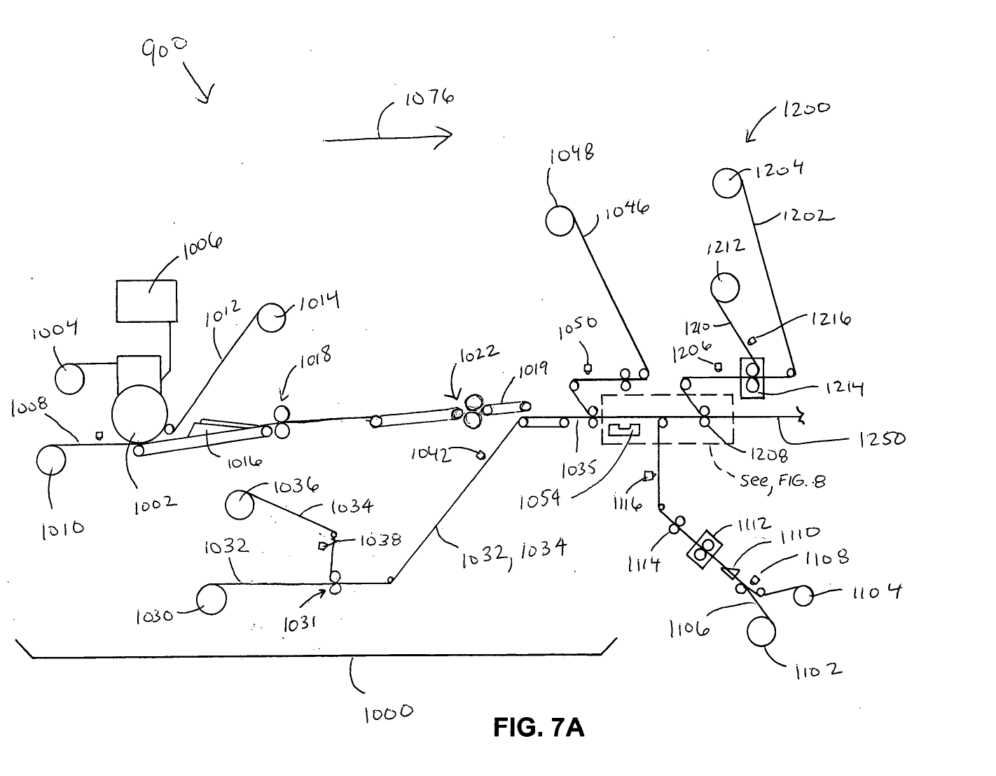

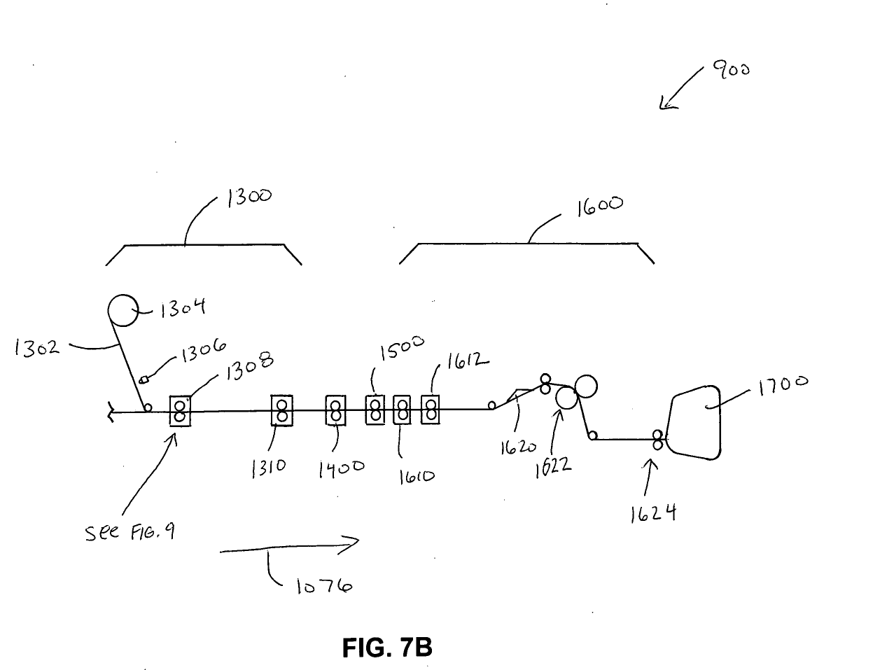

One suitable approach for manufacturing the disposable diaper 20 is as follows. Referring to FIGS. 7A and 7B, shown schematically is one embodiment of a manufacturing system 900 that may be used to manufacture the diaper 20. System 900 is made up of several subsystems or modules. In particular, system 900 may include: an absorbent member module 1000 for making a continuous web of absorbent assemblies 60; a flap forming module 1100; an outer layer module 1200; a fastener module 1300; a waist panel module; an ear bonder 1500; a cut and fold module 1600 and a stacker 1700. System 900 may be arranged differently than shown in FIGS. 7A, 7B, as described herein.

Referring to FIG. 7A, at or near the beginning of the manufacturing process, the absorbent member module 1000 creates the absorbent assembly 60 (described herein) by first forming it into a continuous assembly or “sausage” as is known in the art. Generally, a forming drum 1002 combines pulp from a pulp unwind 1004 and optional superabsorbent material (“sam”) from a source 1006 into a “fluff-sam” mixture. The fluff-sam mixture (not shown) may be placed onto wrap-sheet web 1008 from a wrap unwind 1010. A spacer material 1012, emanating from unwind 1014, may be introduced on top of the sam-fluff material prior to having the wrap sheet web 1008 folded about the sam-fluff material. An adhesive applicator 1011 may dispose an adhesive bead or spray onto a side edge of the wrap-sheet web 1008 so that the wrap sheet web 1008 is secured about the fluff-sam mixture and optional spacer web 1012 after passing through a pad wrapping device 1016. Though desirable, spacer web 1012 and wrap sheet web 1008 are optional components, and it is contemplated that a simple web of fluff-sam mixture may be formed without such components.

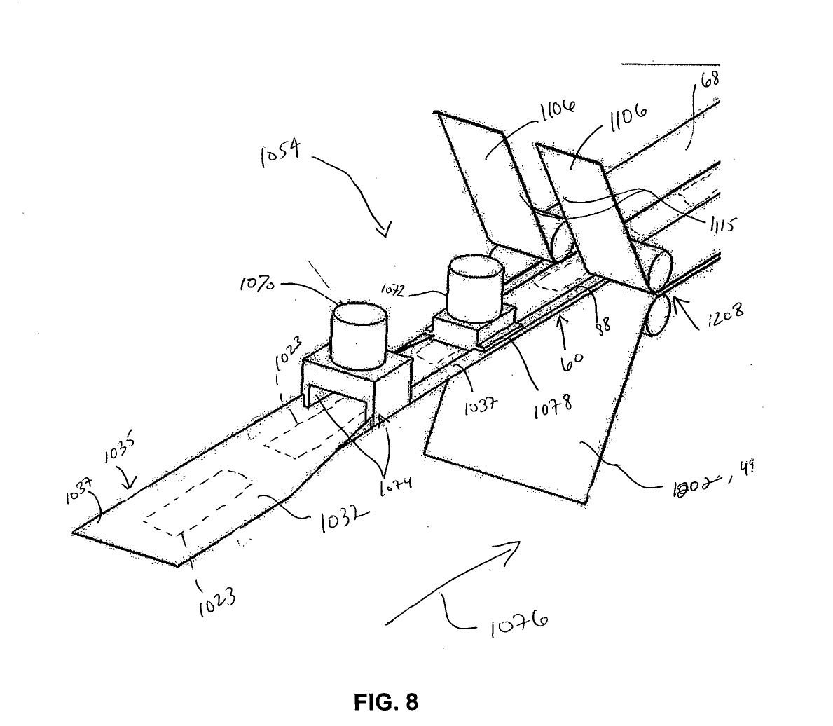

Regardless of whether a wrap sheet web 1008 and/or spacer web 1012 is used in conjunction with the fluff-sam material, the fluff-sam material next passes through a nip 1018 that may be used to debulk or densify the fluff-sam mixture into a pad 1019. The continuous pad 1019 is then dissected laterally by a pad cutter 1022 to form discrete pads 1023 (see FIG. 8).

In another section of the absorbent member module 1000 there exists a topsheet or liner unwind 1030. (The terms topsheet and liner are used interchangeably.) A liner web 1032 proceeds from the liner unwind 1030 to an optional surge applicator 1031.

When the optional surge material is used, surge web 1034 proceeds from a surge layer unwind 1036 to the surge applicator 1031. If desired, a surge adhesive applicator 1038 applies an adhesive to the surge web 1034 before proceeding to the surge applicator. The surge web 1034 may be aligned along the longitudinal centerline of the liner web 1032 and desirably, adhesively attached to the liner web 1032.

The liner web 1032 and optional surge web 1034 proceed past an adhesive applicator 1042 that applies a discrete or continuous, bead or spray of adhesive on or near the longitudinal centerline of the liner web 1032, or if present, the surge web 1034. This adhesive is used to attach the discrete pads 1023 (FIG. 8) to the liner web 1032 and/or surge web 1034. Discrete pads 1023 are disposed on the liner web 1032 and optional surge web 1034 prior to the attachment of a backsheet web 1046.

Backsheet web 1046 is introduced to the system 900 from a backsheet unwind 1048. Desirably, a full body-facing surface of backsheet web 1046 has an adhesive applied thereto by an adhesive applicator 1050, such as by spray, swirls, beads, or the like. The backsheet web 1046 is stacked upon the liner 1032 so that the discrete pad 1023 and optional surge web 1034 is sandwiched therebetween. Suitably, the “sausage stack” 1035 proceeds through a nip 1052 so that the adhesive presses the layers of the sausage stack together for better adhesion.

Referring to FIG. 8, the sausage stack 1035 is folded to create pleats. For example, the outer edges 1037 may be folded over into a simple C-fold as shown, or may be folded into a Z-fold or other types of fold configurations by a folding device 1054. Folding device 1054 may include a series of vacuum folding devices such as a vertical folder 1070 and a horizontal folder 1072. (Note that the terms “vertical” and “horizontal” are used relative to the orientation of web 1032. With respect to the floor of a manufacturing facility, these components may not be oriented horizontally or vertically.) Vertical folder 1070 has a pair of slotted arms 1074 in which the continuous outer edges 1037 progresses through as the web 1032 moves in the machine direction 1076. Each slotted arm 1074 has a vertical slot that raises the outer edge 1037 to a position that is about normal to the remainder of web 1032. The horizontal folder 1072 includes a pair of slotted arms 1078 in which the continuous outer edges 1037 progresses through as the web 1032 moves in the machine direction 1076. Each slotted arm 1078 has a horizontal slot that lowers the outer edge 1037 to a position that about parallel to the remainder of web 1032. In an alternative embodiment, rather than simply fold the outer edges 1037 over into various C-folds, any portion between the edges may be folded or pleated (not shown). The sausage stack 1035, which is the continuous web of assembly 60, is now ready to be attached to other components of diaper 20. Rather than use a vacuum folding device, it is further contemplated that a mechanical folding method may be used, such as folding bars or wheels, as in known in the art.

Refer back to FIG. 7A. Like the continuous web of absorbent assembly 60, the side panels 68 are constructed separately by flap forming module 1100, and then placed in registration with the continuous web of absorbent assembly 60 and attached to the lateral edge margins 88 of the absorbent assembly by the adhesive layer 159, described above. For instance, the side panel web 1106 is introduced into system 900 from a flap unwinder 1102. Elastic members 80 (as seen in FIG. 2) proceed from a flap elastic unwinder 1104, and are adhered to a surface of the side panel web 1106 after passing together through an adhesive applicator 1108. The flap portion 70 (see FIG. 2) is formed when an edge of the side panel web 1106 is folded over to sandwich the adhesive and elastic members 80 within the fold (see FIG. 3). A flap bonder 1112, desirably an ultrasonic bonder, is used to bond the inside edge 61 of flap portion 70 to the remainder of side panel 68. However, it is further contemplated that the flap bonder 1112 could use pressure, heat, and/or an optional adhesive 67 to create a bond at the inside edge 61. Desirably, the bond at inside edge 61 does not overlap or interfere with the elastic members 80.

The side panel web now has a pair of flap elastics, elastic strands 80, formed within the flap portion 70 on each side of the absorbent assembly. The side panel web 1106 is split at about the longitudinal centerline by a slitter 1114 to create a pair of side panels 68. Desirably, an applicator 1116 applies an adhesive to inner edges 1115 (see FIG. 8) of each side panel 68 for attachment to the continuous web of absorbent assembly 60.

Referring now to FIGS. 7A and 8, the continuous web of absorbent assembly 60 and continuous webs of side panel 68 are joined to an outer layer 48. The outer layer 48 is an outer layer web 1202 that proceeds from an outer layer unwinder 1204. An adhesive may be applied to the body-facing surface of the outer layer web 1202 and then secured to a surface of the absorbent assembly 60 after the passing through a nip assembly 1208.

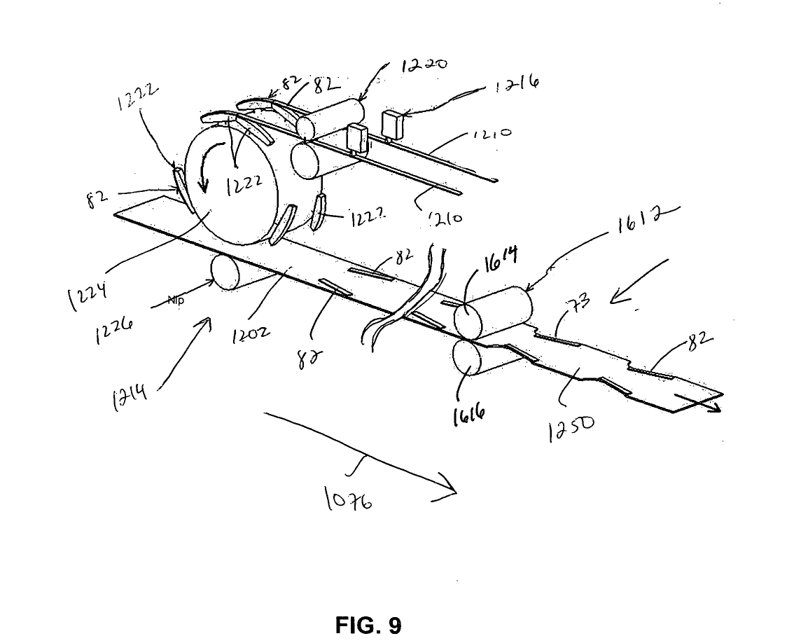

Leg elastic members or elastic leg bands 82 are initially joined to either the side panels 68 (not shown) or outer layer 48 (as shown in FIG. 9). Elastic bands 82 may be disposed onto the outer layer 48 (outer web 1202) at an angle as shown, or may be oriented about parallel to the longitudinal axis of outer layer web 1202. Likewise, elastic bands 82 may be disposed on the side panels in an angled or parallel orientation. Most suitably, elastic leg bands 82 are joined to outer layer 48 prior to the application of the side panels 68.

As seen in FIGS. 7A and 9, elastic band webs 1210 proceed under tension from an unwind 1212 to a leg elastic applicator 1214. Suitably, before the elastic band webs 1210 reach the leg elastic applicator 1214, an adhesive applicator 1216 applies adhesive to the garment-facing surface of each elastic band web 1210. Adhesive is applied as a spray, swirls, beads, or the like. Referring to FIG. 9, the elastic band webs 1210 proceed to a perforation nip 1220. Perforation nip 1220 intermittently cuts and separates the elastic band webs 1210 into discrete elastic band members 82, which are then carried to the outer layer web 1202. As the elastic bands 1220 are perforated, they are picked up and carried by vacuum pucks 1222 as described in U.S. Pat. No. 5,716,478 issued to Boothe, et al. on Feb. 10, 1998, incorporated herein to the extent that it is consistent with the present invention. Generally, the discrete elastic bands 82 are accelerated around a drum 1224 by vacuum pucks 1222 so the elastic bands are disposed onto the body-facing surface of the outer layer web 1202. Vacuum pucks 1222 may rotate slightly to achieve the angled placement of the elastic bands, if desired. The drum 1224 forms a nip against nip roll 1226 to secure the elastic bands 82 onto the outer layer web 1202. The outer layer web 1202 proceeds in the machine direction 1076.

Referring now to FIG. 7B, fasteners may be applied to the disposable absorbent garment using the fastener module 1300. Desirably, the “composite web” 1250 now includes the sausage stack 1035, the outer layer web 1202 and the side member web 1106. It may be desirable to place a fastener 92 on the garment facing surface of the outer layer 48 (also outer layer 1202) as described herein (see FIG. 1). As is known in the art, the fastener web 1302, e.g. a hook material, emanates from unwind 1304 and proceeds to an application device 1308 after passing through an adhesive applicator 1306. Similar to the process used with the leg elastic applicator 1214, the fastener web 1302 is cut into discrete fasteners 92 and adhesively applied to the outer layer web 1202.

Further, as is known in the art, ears 88 are disposed on the waist region of the diaper 20 using the ear applicator 1310. Suitably, the ears 88 are joined at the laterally opposite side edges of the chassis adjacent the back waist region 24. More suitably, each ear 88 has a longitudinal length equal the back elastic waist panel longitudinal length 84, and aligned and joined adhesively, ultrasonically, and/or by thermal bond to opposite ends of the back elastic waist panel 64 at the outboard edge 73 (see FIG. 1).

Elastic waist panels 62, 64 are adhesively attached to the front and rear waist regions 22, 24 so that they extend laterally across the body-facing surface of the composite web 1250. Referring to FIG. 7B, the waist panel applicator module 1400 applies discrete waist panel segments (not shown) simultaneously across front and rear waist regions 22, 24 such that when the composite web 1250 is cut into discrete diapers 20, the discrete waist panel segments become elastic waist panels 62 and 64 for two separate diapers 20, as is known in the art.

Using an ear bonding module 1500 as is known in the art, each ear 88 is bonded to opposite ends of the back elastic waist panel 64 at the outboard edge 73 (see FIGS. 1 and 7B). Suitably, the bond area 86 used to attach ears 88 to back waist panel 64, the bond being an ultrasonic or thermal bond that joins the ears 88 and rear waist panel 64 to the outer layer 48. Most suitably, the materials within the bond are rendered non-extensible by the bonding process.

Referring to FIGS. 1 and 7B, a cut and fold module 1600 includes an end-seal bonder 1610 for creating the first bond zone 126 and the second bond zone 129 as described herein. First bond zone 126 and second bond zone 129 may be a continuous bond or three discrete areas at the waist edge. It is further contemplated that the first bond zones 126 may extend as far as the laterally outboard edges 73. Suitably, if the bond zones are extended as far as the laterally outboard edges 73, point bonds are used so that any elastic or stretchable characteristic of the elastic waist panel 62 or 64 is not greatly diminished.

Further, the cut and fold module includes a leg die 1612 which cuts through the elastic band 82 that is sandwiched between side panels 68 and the outer layer 48. Creating a leg cut-out defined by laterally outboard edge 73 (see also, FIG. 1) provides the advantage of having a non-ruffled edge. Because laterally outboard edge 73 is smooth and not ruffled, it appears more like a cuff as found on durable underwear, and may lie flatter against the wearer's body for better sealing against leakage. A further advantage is that by cutting the elastic band 82, it may be tapered to provide varying degrees of tension along the laterally outboard edge 73. Suitably, the narrow end of elastic band 82 terminates in the crotch region of diaper 20. It is contemplated that other cutting methods may be used, such as water or laser cutting methods.

As suggested by FIG. 8, leg die 1612 is a nip formed by a knife roll 1614 and an anvil roll 1616. The knife roll 1614 may be located at the garment-facing surface or the body-facing surface of composite web 1250. Desirably, the knife roll 1614 has a cutting member (not shown) shaped into a desired shape for a leg cut-out, e.g. a curved shape.

Finally, referring back to FIG. 7B, as is known in the art, the ears 88 are folded by ear folder 1620 and the composite web 1250 is sequentially cut into discrete diapers 20 by a final cutter 1622. In the embodiment as shown, the diapers 20 are made in an end-to-end or machine-direction process. However, it is contemplated that a cross-direction process may be used. The diapers 20 are each folded and tucked by diaper folder 1624 and placed into a stack by a stacker 1700, as is known in the art.

When introducing elements of the present invention or the preferred aspect(s) thereof, the articles “a,” “an,” “the,” and “said” are intended to mean that there are one or more of the elements. The terms “comprising,” “including,” and “having,” are intended to be inclusive and mean that there may be additional elements other than the listed elements.

As various changes could be made in the above constructions without departing from the scope of the invention, it is intended that all matter contained in the above description or illustrated in the accompanying drawings shall be interpreted as illustrative and not in a limiting sense. For example, where practical, an adhesive bond may be replaces by other types of bonds, e.g. ultrasonic, thermal, and the like.

What is claimed is:

1. A method of manufacturing a disposable garment wearing about the lower torso of a person, the garment comprising a crotch region extending longitudinally between and interconnecting a front waist region and a back waist region, the method comprising the steps of:
orienting a pair of elastic leg bands in a longitudinal direction;
laterally spacing the pair of elastic leg bands apart from one another;
attaching each one of the pair of elastic leg bands to a lateral edge margin of the crotch region of the disposable garment; and
cutting through the pair elastic leg bands and the lateral edge margin of the disposable garment to define a shaped leg cut-out.

2. The method of claim 1 wherein the garment is constructed by disposing an outer layer in opposed relationship with an inner layer.

3. The method of claim 2 further comprising the step of disposing the pair of elastic leg bands between the outer layer and the inner layer.

4. The method of claim 1 further comprising the step of disposing an absorbent assembly between the outer layer and the inner layer, and between the laterally spaced pair of elastic leg bands.

5. The method of claim 4 further comprising the steps of creating a pleat in the absorbent assembly, and permanently bonding the pleat to the outer layer at a bond zone located adjacent a waist opening.

6. The method of claim 1 further including the step of positioning the pair of elastic leg bands such that they extend from the back waist region to the crotch region garment.

7. The method of claim 1 wherein the step of cutting through the pair elastic bands and the lateral edge margin of the disposable garment to define a shaped leg cut-out further comprises the step of shaping each one of the pair of elastic leg bands such that each one has a wide end and a narrow end.

8. The method of claim 7 further comprising the steps of disposing the narrow end in the crotch region, and disposing the wide end in the back waist region.

9. The method of claim 1 further comprising the step of positioning one end of each one of the pair of elastic leg bands in the back waist region, and positioning an opposite end of each one of the pair of elastic leg bands in the crotch region, and laterally distancing ends located in the back waist region farther apart than opposite ends located in the crotch region.

10. A method of manufacture of a disposable garment comprising the steps of:
forming a composite web by providing a continuous web of absorbent assembly having lateral edge margins, and comprising a plurality of discrete pads spaced apart longitudinally in a machine direction and disposed between a liner web and a backsheet web; joining a pair of side panel webs, spaced apart in a lateral direction, to the lateral edge margins of the continuous web of absorbent assembly; joining discrete, laterally and longitudinally spaced pairs of leg elastic members to an outer layer web; and sandwiching the leg elastic members between the outer layer web and the side panel webs;
cutting through the composite web at the outer layer web, the side panel webs, and the leg elastic members to define a pair leg cut outs at laterally spaced outboard edges; and
cutting the composite web at longitudinally spaced intervals to form discrete disposable garments.

11. The method of claim 10 wherein the leg elastic members define a length and the step of cutting step through the composite web further comprises tapering the leg elastic members such that each of the leg elastic members become gradually narrower along the length thereof to create a narrow end and a wide end.

12. The method of claim 11 further including the step of disposing the narrow end of each leg elastic member in the crotch region.

13. The method of claim 10 further including the step of bonding ear members to opposite lateral side edges of the back waist region.

14. The method of claim 13 wherein the ear members are positioned within about 7 mm of the leg elastic members.

15. The method of claim 10 further comprising the step of positioning each of the leg elastics at laterally outboard edges of the garment so that each leg elastic has a first end located within about 7 mm of a laterally extending rear elastic waist panel disposed at the back waist region, and a second end terminating in the crotch region.

16. The method of claim 10 wherein the step of cutting through the composite web is performed with a die cutter.

17. The method of claim 10 further comprising the step of attaching an elastic waist panel at each of the front waist region and the rear waist region.

18. The method of claim 17 further including the step of bonding ear members to the elastic waist panel at opposite lateral side edges of the back waist region, the ear members disposed within about 7 mm of the leg elastics.

19. The method claim 10 further comprising the step of permanently bonding together the elastic waist panel, the outer layer, and the inner layer at a bond zone adjacent the waist opening.

20. The method of claim 20 wherein the inner layer has a pleat or fold at the bond zone.
